(19) United States
(12) Patent Application Publication
(10) Pub. No.: US 2024/0003402 A1
(43) Pub. Date: Jan. 4, 2024

(54) VIBRATION DAMPER AND METHOD FOR ASSEMBLING THE VIBRATION DAMPER

(71) Applicant: ZF FRIEDRICHSHAFEN AG, Friedrichshafen (DE)

(72) Inventors: Hartmut RÖLLEKE, Kircheib (DE); Patrick SCHNEIDER, Siershahn (DE); Mathias BALENSIEFER, Eitorf (DE); Alexander AU, Windeck (DE)

(21) Appl. No.: 18/217,528

(22) Filed: Jul. 1, 2023

(30) Foreign Application Priority Data
Jul. 4, 2022 (DE) 10 2022 206 781.9

(51) Int. Cl. F16F 9/58; F16F 9/32; F16F 9/06

(52) U.S. Cl. CPC F16F 9/58; F16F 9/3235; F16F 9/062; F16F 2226/04; F16F 2232/08

(57) ABSTRACT

Vibration damper, including a piston rod, axially movably guided in a work cylinder, with a piston, wherein the work cylinder is closed at the end by a piston rod guide, and the vibration damper has a securing device during an assembly process so that at least a length portion of the piston rod passes through the piston rod guide. The securing device is formed by a supporting ring that is guided axially displaceably in the work cylinder and, in the fully assembled vibration damper, assumes an axial position inside the work cylinder in a length region which is delimited on one side by the piston and on the other side by a base part of the work cylinder.

### BACKGROUND OF INVENTION

### 1. Field of the Invention

The disclosure relates to a vibration damper and a method for assembling a vibration damper.

### 2. Description of Related Art

An axial installation space for a vibration damper is generally always very small, and therefore a piston on a piston rod moves in as far as the immediate vicinity of a base valve and on the other hand moves out until a minimum guide length within a work cylinder is reached.

To a lesser extent, there are however also designs in which a cylinder that is comparatively long in comparison with the stroke length of the piston is used. In this case, the situation can arise during the assembly of the cylinder that the piston rod together with the piston penetrates so deeply into the work cylinder that the piston rod does not have a sufficient axial projection relative to a piston rod guide. A pin joint or an eyelet is not installed until a late point in the assembly process, and therefore the piston rod can move in unimpeded. There is not yet any gas filling inside the vibration damper either, so the resulting pressure force on the piston rod likewise cannot be used to support the piston rod.

To solve this problem, it is known from the prior art to use a shorter work cylinder and to provide an axial extension between a base of the vibration damper and a connection element. On the one hand, the length of the work cylinder and the amount of damping medium inside the vibration damper can be reduced, but at least one additional welding operation must be introduced for the use of the axial extension.

If the length of the work cylinder is made longer than absolutely necessary in a vibration damper of monotube design, a separating piston can also be used as a support between a gas-filled reserve chamber and a work chamber remote from the piston rod. This approach is known for example from DE 103 52 697 A1.

### SUMMARY OF THE INVENTION

An object of one aspect of the present invention is a further solution to the problem of installing the piston rod inside the work cylinder.

According to one aspect of the invention, a securing device is formed by a supporting ring that is guided axially displaceably in the work cylinder and, when the vibration damper is fully assembled, assumes an axial position inside the work cylinder in a length region which is delimited on one side by the piston and on the other side by a base part of the work cylinder.

With the use of the supporting ring, the piston rod length can be reduced independently of the design of the vibration damper and problem-free assembly can still be achieved.

In one aspect of the invention, the piston has an annular face that correlates with an end face of the supporting ring. The dimensional accuracy or other nature of the annular face is of lesser importance, since the annular face is only used as a force transmission face for a single assembly process.

According to one aspect of the invention, the supporting ring has a supporting face that is axially opposite the end face. The supporting face is intended to ensure a state in which the supporting face bears against the base part of the work cylinder. With a defined supporting face on the supporting ring, the position thereof inside the work cylinder and optionally also on the base part is predefined.

In one aspect of the invention, the supporting ring can have a shoulder on the end face and/or on the supporting face to receive at least one valve disc on the piston and/or on the base. As a result, there is sufficiently large free movement for valve discs on the piston and/or on the base part. Sticking or blockage of the lift-off movement of the valve disc is thus excluded.

Optionally, the work cylinder can have an axial stop to support the supporting ring. The axial stop is useful for example if the supporting ring is never intended to rest on a base part of the work cylinder, since the work cylinder does not have a sufficiently large free face for the supporting ring. A further reason can consist in that the supporting ring could at least partially close a transverse opening in the work cylinder.

In an alternative solution, the vibration damper has, as a securing device, a connection for an adapter rod, the diameter of which corresponds to the diameter of the piston rod. This solution offers the advantage that no sacrificial components at all have to be accepted in order to be able to use a shorter piston rod. The adapter rods remain in the manufacturing process and can always be reused, since they are not subject to any wear either.

In a method for assembling the vibration damper, the work cylinder is fitted with the base part at the end, and the supporting ring is clamped against an inner wall of the work cylinder between the open end of the work cylinder and the base part, wherein the unit consisting of piston rod and piston is then introduced into the work cylinder, and the work cylinder is closed by the piston rod guide, wherein the piston rod is held by the supporting ring in a position in which at least the length portion of the piston rod protrudes from the piston rod guide, wherein the vibration damper is filled completely with a damping medium volume and a gas volume before the piston rod passes through along a piston rod stroke path, wherein the supporting ring is displaced by the piston into a final position outside the working range of the piston.

No specific tool is needed for the displacement of the supporting ring; rather, the piston rod together with the piston constitutes the manufacturing tool.

Alternatively, the work cylinder is fitted with the base part at the end, and the piston rod is extended using the adapter rod and introduced into the work cylinder. Then the vibration damper is completely filled with a damping medium volume and a gas volume, wherein the adapter rod is removed from the piston rod after the process of filling the vibration damper. A specific tool is not needed for this method either. With the introduction of the assembly steps relating to the installation and removal of the adapter rod, an otherwise unchanged manufacturing process can be continued.

Before the securing device is deactivated, the vibration damper is subjected to an operation test before finally being closed. A vibration damper with damping force characteristics not conforming to the desired requirements can be post-machined if needed.

### BRIEF DESCRIPTION OF THE DRAWINGS

The invention is explained in more detail using the following description of the figures.

In the figures:

FIGS. 1A and 1B are a vibration damper with a supporting ring;

FIGS. 2A to 2C are a vibration damper with an adapter rod; and

FIG. 3 is a work cylinder with an axial stop for the supporting ring

### DETAILED DESCRIPTION OF THE PREFERRED EMBODIMENTS

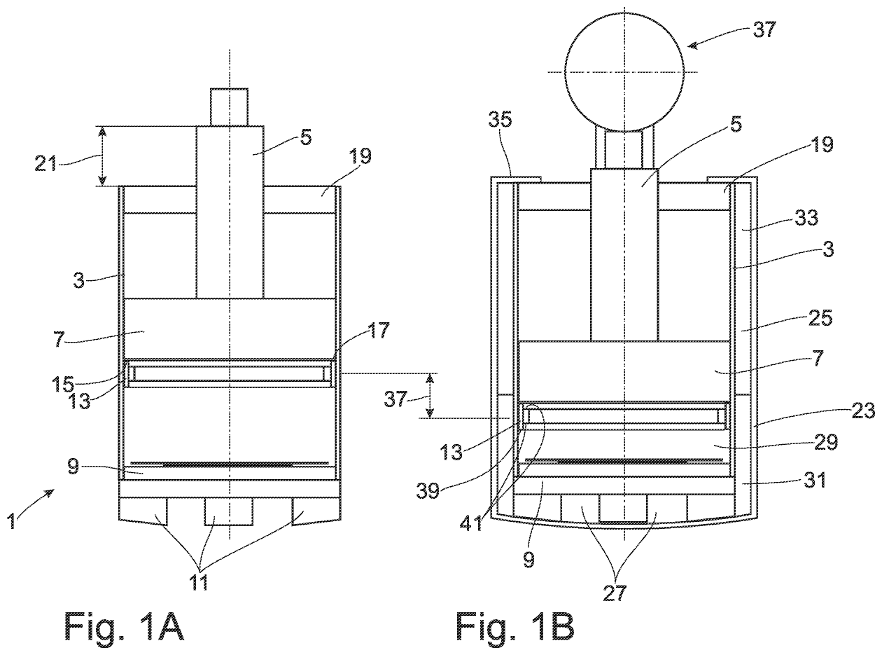

FIG. 1 shows a vibration damper 1 of any desired design in a highly simplified manner. An axially movably guided piston rod 5 with a piston 7 is arranged in a work cylinder 3. The piston 7 can be in the form of a simple displacement element, but also in the form of a valve body with valve discs. As can be seen immediately, the piston rod 5 is relatively short in comparison with the usable length of the work cylinder 3. The work cylinder 3 has a base part 9, which can be part of the work cylinder 3 but can also be formed by a separate base valve body.

During the assembly process, the piston 7 is connected to the piston rod 5. Independently of this, the work cylinder 3 is provided with the base part 9. In FIGS. 1A and 1B, a base valve body is used that has supporting cams 11 on a rearward face from the piston 7. Furthermore, the vibration damper 1 has a securing device for supporting the piston rod 5 during the assembly process. The securing device used is a supporting ring 13, which is guided axially displaceably in the work cylinder 3. The supporting ring 13 is held force-fittingly in the work cylinder 3 and is situated at a defined distance from the still open end of the work cylinder 3 at the start of the assembly process.

During assembly, the unit consisting of piston rod 5 and piston 7 is inserted into the otherwise empty work cylinder 3. In the process, an annular face 15 of the piston 7 comes to rest on an end face 17 of the supporting ring 13. The end face 17 correlates with the annular face 15 so that contact between a valve disc on the piston and the supporting ring 13 can be excluded.

In a further assembly step, the work cylinder 3 is closed at the end by a piston rod guide 19. Owing to the support of the piston rod 5 by means of the exactly positioned supporting ring, at least a length portion 21 of the piston rod 5 passes through the piston rod guide. This length portion 21 is dimensioned according to the requirement of a filling device (not shown), which surrounds the piston rod 5. Depending on the design of the vibration damper 1, the term “closed” in connection with the piston rod guide 19 does not yet necessarily mean that the piston rod guide 19 is fixed in the work cylinder 3.

In this example, the work cylinder 3 assembled according to FIG. 1A is placed into an outer container tube 23. In principle, this work step can also be carried out before the piston rod guide 19 is installed. The container tube 23 and the work cylinder 3 delimit an annular chamber that acts as a reserve chamber 25 for the displaced volume of the piston rod situated in the work cylinder. The reserve chamber 25 is connected to a work chamber 29 remote from the piston rod via ducts 27 between the supporting cams 11.

In principle, the reserve chamber 25 can also be formed by a separate reservoir connected to the work cylinder 3 via a hose, for example. In that case, a container tube 23 would also be superfluous.

In a further work step, the work cylinder 3 is filled with a defined damping medium volume 31 and with a defined gas medium volume 33. In the prior art, various filling techniques are known, for example, along a duct inside the piston rod guide or else in the wall of the work cylinder. The specific filling technique is irrelevant to the use of the invention.

With the introduction of the gas medium volume 33, the damping medium volume 31 inside the vibration damper 1 is placed under a defined operating pressure. This operating pressure also acts on the piston rod-piston unit 5; 7 and thus pushes this unit in the direction of the piston rod guide 19. The piston rod can therefore no longer sink under its own weight into the work cylinder 3.

If required, tests can then be carried out on the vibration damper, for example checking the damping force behaviour. The vibration damper 1 is then closed, for example by flanging an edge 35 of the container tube 23 protruding relative to the piston rod guide 19. Alternative closure techniques are also known to a person skilled in the art. At the latest after the tests, a connection element on the piston rod side is connected to the piston rod 5.

Then the piston rod 5 is inserted into the work cylinder 3 according to the displacement distance 37 so deeply that the supporting ring 13 is displaced by the piston 7 inside the work cylinder 3 into an axial position which lies in a length region between the piston 7 and the base part 9 of the work cylinder 3. No damaging contact then occurs between the supporting ring and the piston during operation of the vibration damper. The dashed line symbolizes the maximum compression position of the piston 7 during operation of the vibration damper.

In particular if it consists of plastic, the supporting ring 13 is subject to a certain ageing process, and therefore the preloading to the wall of the work cylinder 3 decreases. It is not a functional defect if the supporting ring falls as far as the base part 9. The supporting ring 13 has a supporting face 39 that is axially opposite the end face 17 and can rest on the base part 9.

The supporting face 39, like the end face 17, can also have a shoulder 41 for receiving at least one valve disc on the base to avoid hindering the operating movement thereof.

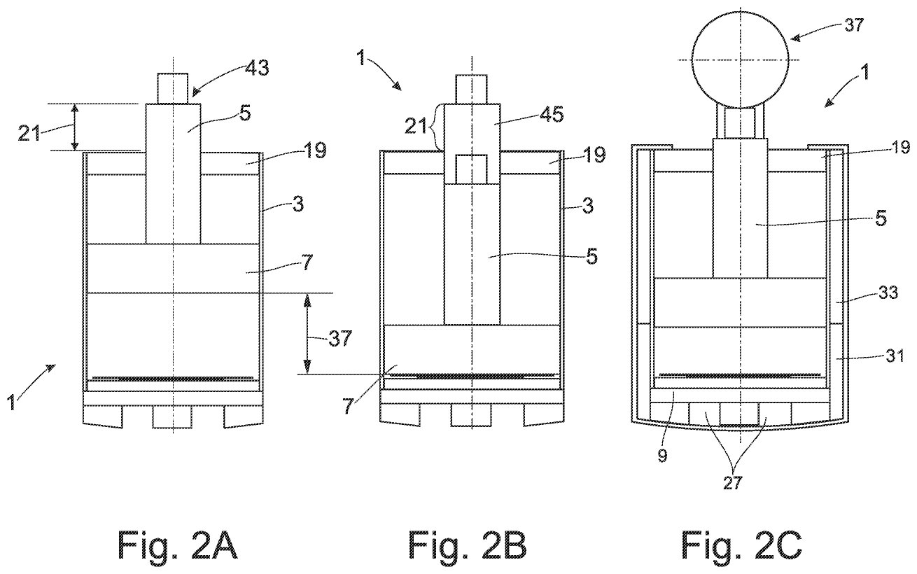

FIG. 2A shows a vibration damper 1 corresponding to the basic structure of FIG. 1A without a supporting ring. As the securing device, the vibration damper 1 has a connection 43 for an adapter rod 45, the diameter of which corresponds to the diameter of the piston rod 5, as shown in FIG. 2B. During the assembly process, the adapter rod 45 is fixed to the piston rod 5 together with the piston 7. The adapter rod 45 could optionally also be attached when the piston rod guide 19 is already inserted into the work cylinder 3.

As FIG. 2B shows, the piston rod 5 together with the adapter rod 45 may sink into the work cylinder 3 by the displacement distance 37, since the length of the adapter rod 45 relative to the length of the piston rod 5 is dimensioned such that the necessary length portion 21 for the filling of the vibration damper 1 is available on the other side of the piston rod guide.

After the introduction of the damping medium volume 31 and the gas medium volume 33, the piston rod moves out of the work cylinder 3 in this design too, so that the adapter rod 45 is removed from the piston rod 5 and is available for reuse.

In this variant too, functional tests can be carried out if required before the vibration damper 1 is finally closed.

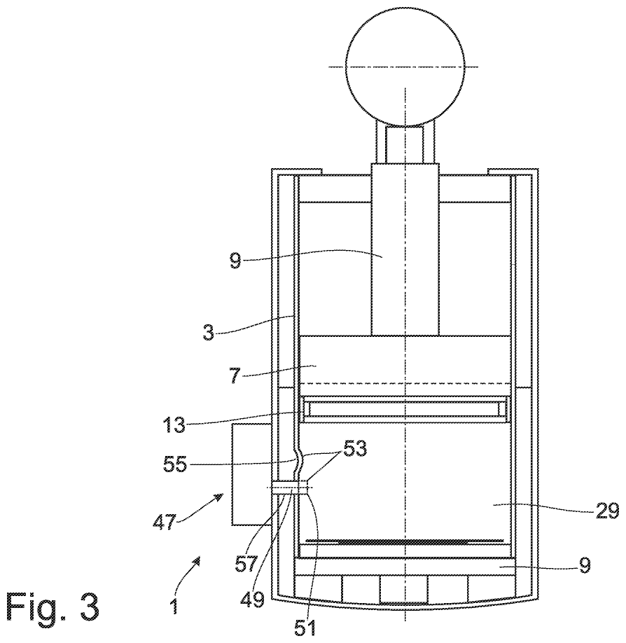

FIG. 3 shows a vibration damper 1 in a simplified embodiment with an external damping valve device 47, as is known from DE 10 2019 215 984 A1, for example. For the invention, the exact structure of the damping valve device 47 is of minor importance. For the hydraulic connection of the damping valve device 47, the vibration damper 1 has at least one fluid duct 49 which opens into a through-opening 51 inside the wall of the work cylinder 3. So that this through-opening 51 cannot be closed by the supporting ring 13 inside the work cylinder 3, an axial stop 53 is formed in the work cylinder 3 on the other side of the intended working stroke of the piston 7 in the direction of the through-opening 51 and in front of same in order to support the supporting ring 13. This axial stop 53 prevents the supporting ring 13 from fully or partially closing the through-opening 51. The axial stop 53 can be formed structurally, for example, by an inwardly directed indentation 55 or else a bead. Alternatively, the fluid duct 49 formed by a tube 57 can protrude somewhat into the work chamber 29 of the work cylinder 3 remote from the piston rod.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A vibration damper, comprising:
a piston rod guide;
a work cylinder, wherein the work cylinder is closed at a first end by the piston rod guide;
a base part of the work cylinder;
a piston rod that is axially movably guided in the work cylinder;
a piston;
a securing device configured such that during an assembly process at least a length portion of the piston rod passes through the piston rod guide, the securing device is formed by a supporting ring that is guided axially displaceably in the work cylinder and, in a fully assembled vibration damper, assumes an axial position inside the work cylinder in a length region delimited on one side by the piston and on an other side by the base part of the work cylinder.

2. The vibration damper according to claim 1, wherein the piston has an annular face that correlates with an end face of the supporting ring.

3. The vibration damper according to claim 2, wherein the supporting ring has a supporting face arranged axially opposite the end face.

4. The vibration damper according to claim 3, wherein the supporting ring has a shoulder on the end face and/or on the supporting face configured to receive at least one valve disc on the piston and/or on the base.

5. The vibration damper according to claim 1, wherein the work cylinder has an axial stop to support the supporting ring.

6. The vibration damper according to claim 1, wherein the vibration damper has, as the securing device, a connection for an adapter rod, a diameter of the connection corresponds to a diameter of the piston rod.

7. A method for assembling a vibration damper having a piston rod guide; a work cylinder, wherein the work cylinder is closed at an end by the piston rod guide; a base part of the work cylinder; a piston rod that is axially movably guided in the work cylinder; a piston; and a securing device formed by a supporting ring that is guided axially displaceably in the work cylinder, comprising:
fitting the work cylinder with the base part at an end;
clamping the supporting ring against an inner wall of the work cylinder between an open end of the work cylinder and the base part,
introducing a unit comprising the piston rod and the piston into the work cylinder;
closing the work cylinder by the piston rod guide;
holding the piston rod by the supporting ring in a position in which at least a length portion of the piston rod protrudes from the piston rod guide;
filling the vibration damper completely with a damping medium volume and a gas volume before the piston rod passes through along a piston rod stroke path; and
displacing the supporting ring by the piston into a final position outside a working range of the piston.

8. The method for assembling the vibration damper according to claim 7,
wherein the piston rod is extended using an adapter rod and introduced into the work cylinder, and
wherein the adapter rod is removed from the piston rod after the filling of the vibration damper.

9. The method according to claim 7, wherein the vibration damper is subjected to an operation test before finally being closed.
